(19) United States
(12) Patent Application Publication
(10) Pub. No.: US 2007/0174619 A1
(43) Pub. Date: Jul. 26, 2007

(54) DIGITAL WATERMARKING SYSTEM ACCORDING TO PIXEL BRIGHTNESS VALUE AND DIGITAL WATERMARKING METHOD

(76) Inventors: Kuan-Hong Hsieh, Shenzhen (CN); Xiao-Fang Chen, Shenzhen (CN); Zai-An Pan, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/307,542

(22) Filed: Feb. 13, 2006

(30) Foreign Application Priority Data
Jun. 17, 2005 (CN) 200510035400.7

(51) Int. Cl. H04L 9/00; G06F 12/14; G06K 9/36; H04L 9/32; G06F 11/30

(52) U.S. Cl. 713/176; 713/189; 382/276

(57) ABSTRACT

A digital watermarking system and method is provided. The digital watermarking system mainly includes a storing unit, a text obtaining module, a pixel determining module, an encrypting module, and a storing module. The storing unit is for storing text information, the text information including one or more dot matrix files. The text obtaining module is for obtaining one dot matrix file to be watermarked from the storing unit. The dot matrix file includes plural dot matrixes, each of the dot matrixes includes plural pixels, each of the pixels has a brightness value. The pixel determining module is for earmarking the pixel to be adjusted, an initial brightness value of the earmarked pixel being in a predetermined range. The encrypting module is for adjusting the brightness value of the earmarked pixel. The storing module is for storing watermarked text information in the storing unit. Related methods are provided.

### TECHNICAL FIELD

The present invention relates to a digital rights protection system and method, and particularly to a digital watermarking system implemented according to a pixel brightness value and a related digital watermarking method.

GENERAL BACKGROUND

The threat of pirating of digitally-formatted works has been a significant obstacle to widespread adoption and use of the Internet for distribution of media such as books, musical works, and motion pictures. Although such network distribution would at first glance seem ideal for these media, which are easily represented in electronic format, there has been no easy way to prevent widespread copying of such works once they are introduced to the public. In many cases, one person will buy a legitimate copy and then distribute copies thereof to friends and others without any further payments to the publisher. This threatens the financial well-being of the publishers, and makes them very reluctant to introduce their works on the Internet.

Therefore, in order to try to solve the above described problems, digital watermarking has been developed. In general, digital watermarking is an alteration of a data set within an electronic file. The watermark can be visible or invisible to human perception.

The invisible, or nearly invisible, watermark is mainly detected by a computer. The computer computes a correlation of the information under scrutiny with an applied watermark pattern, and compares the result of the correlation with a predetermined threshold. If the difference is greater than the threshold, the watermark is said to be present; otherwise, it is said to be absent. The greater the difference, the more reliable the detection. However, with respect to a work embedded with such a watermark, a great deal of computing is needed to detect the watermark and identify copyright notices or other verification messages in the work. In addition, once the work is printed, it becomes more difficult to accurately read or interpret the information contained in the watermark, due to the imperceptible characteristics of the watermark.

What is needed, therefore, is a digital watermarking system and method, which can efficiently watermark text and generate a perceptible watermark.

SUMMARY

A digital watermarking system is provided. The digital watermarking system mainly includes a storing unit, a text obtaining module, a pixel determining module, an encrypting module, and a storing module. The storing unit is for storing text information, the text information including one or more dot matrix files. The text obtaining module is for obtaining a dot matrix file to be watermarked from the storing unit. The dot matrix file includes a plurality of dot matrixes, each of the dot matrixes includes a plurality of pixels, and each of the pixels has a brightness value. The pixel determining module is for earmarking the pixel to be adjusted to obtain a watermark, an initial brightness value of the earmarked pixel being in a predetermined range. The encrypting module is for adjusting the brightness value of the earmarked pixel, the adjustment being either increasing or decreasing the brightness value. The storing module is for storing watermarked text information in the storing unit.

A digital watermarking method is also provided. The method includes the steps of: (a) obtaining text information to be watermarked, the text information including one or more dot matrix files each of which includes a plurality of dot matrixes, each dot matrix including a plurality of pixels, and each pixel having a brightness value; (b) earmarking the pixel to be adjusted to obtain a watermark, an initial brightness value of the earmarked pixel being in a predetermined range; (c) adjusting the brightness value of the earmarked pixel, the adjustment being either to increase or decrease the brightness value; and (d) storing watermarked text information in a storing unit.

Another digital watermarking method is further provided. The method includes the steps of: (a) obtaining text information to be watermarked, the text information including one or more dot matrix files each of which includes a plurality of dot matrixes, each dot matrix including a plurality of pixels, and each pixel having a brightness value; (b) obtaining a dot matrix from the obtained text information if a length of a bit sequence is not equal to zero, the bit sequence being for indicating copyright, author, etc; (c) earmarking the pixel of the obtained dot matrix to be adjusted, an initial brightness value of the earmarked pixel being in a predetermined range; (d) adjusting the brightness value of the earmarked pixel according to a bit value of one bit of the bit sequence; (e) recording the adjusted pixel and corresponding bit value; and (f) storing watermarked text information.

Other advantages and novel features will be drawn from the following detailed description with reference to the attached drawings, in which:

### BRIEF DESCRIPTION OF DRAWINGS

FIG. 1 is a schematic diagram of an exemplary dot matrix file in accordance with a preferred embodiment of the present invention, the dot matrix file including a plurality of dot matrixes;

FIG. 2 is a schematic diagram of an exemplary dot matrix of the dot matrix file of FIG. 1, the dot matrix including a plurality of pixels;

FIG. 3 is a schematic diagram of main function modules of a digital watermarking system in accordance with a preferred embodiment of the present invention;

FIG. 4 is a flowchart of a preferred method for digital watermarking in accordance with another embodiment of the present invention;

FIG. 5 is a flowchart of a first preferred method of implementing one step of FIG. 4, namely determining pixels to be adjusted;

FIG. 6 is flowchart of a second preferred method of implementing the same step of FIG. 4, namely determining pixels to be adjusted;

FIG. 7 is a flowchart further detailing steps involved in digital watermarking utilizing a combination of the preferred methods of FIGS. 4 and 5;

FIG. 8 is a flowchart further detailing steps involved in digital watermarking utilizing a combination of the preferred methods of FIGS. 4 and 6; and

FIG. 9 illustrates exemplary adjustment results of a watermarked dot matrix obtained by utilizing the method of either FIG. 7 or FIG. 8.

### DETAILED DESCRIPTION

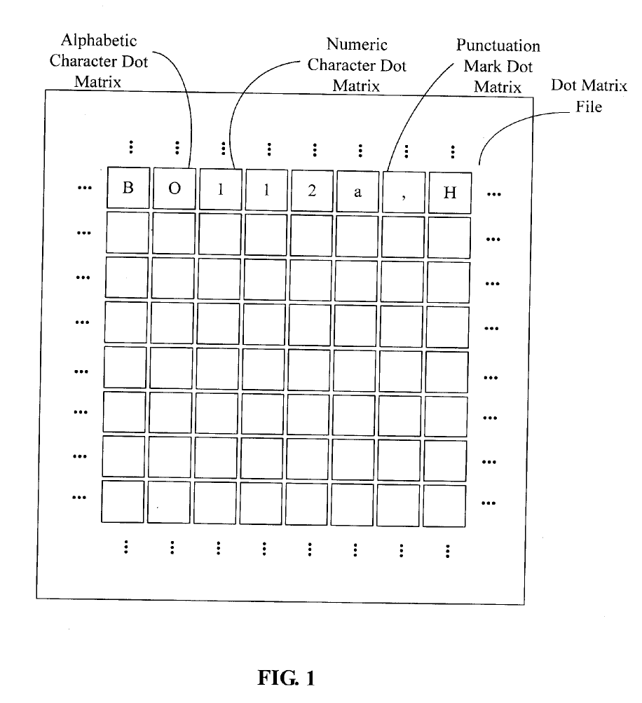

FIG. 1 is a schematic diagram of an exemplary dot matrix file in accordance with a preferred embodiment of the present invention, the dot matrix file including a plurality of dot matrixes. Generally, a text comprises a collection of data of a regular structure representing such things as characters and punctuation marks. The characters can be either alphabetic characters or numeric characters. Each character, as well as each punctuation mark, is represented by and stored as a dot matrix. Correspondingly, the dot matrixes are grouped into two sorts based on their character type; i.e., alphanumeric or punctuation. In this description, unless the context indicates otherwise, alphanumeric means alphabetic or numeric.

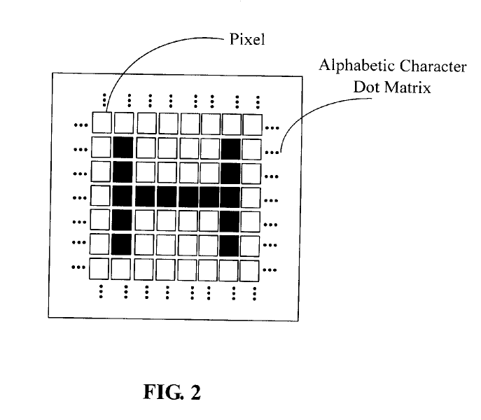

FIG. 2 is a schematic diagram of an exemplary dot matrix of the dot matrix file of FIG. 1. The dot matrix includes a plurality of pixels each being represented by a square. Each pixel has a brightness value expressed as a combination of red, green and blue (“RGB”) colorants. Colorant values of each pixel typically are represented as multi-bit digital data values. Thus, if eight bits are used for each colorant, the colorant values may range from 0 to 255. That is, a range of gray level gradations from black to white is defined for each colorant. With respect to each gray level, the higher the gray level the higher the brightness value is, and the less likely human eyes will be able to perceive the corresponding pixel (i.e., black text becomes lighter and lighter against a white background). In this regard, in the preferred embodiment, pixels are regarded as being visible if their brightness values are in the range from [0,0,0] to [200,200,200]. Correspondingly, pixels are regarded as being invisible if their brightness values are in the range from (200,200,200) to [255,255,255]. However, the ranges can be different in other embodiments. In FIG. 2, the black squares represent pixels that are visible, and the white squares represent pixels that are invisible. Further, the pixels represented by black squares have the same initial brightness value (e.g., RGB=[128,128,128]), and the pixels represented by white squares have the same initial brightness value (e.g., RGB=[255,255,255]).

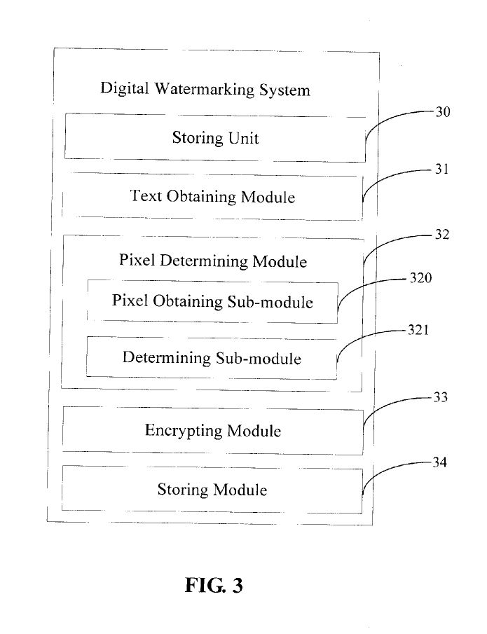

FIG. 3 is a schematic diagram of main function modules of a digital watermarking system in accordance with a preferred embodiment of the present invention. The digital watermarking system mainly includes a storing unit 30, a text obtaining module 31, a pixel determining module 32, an encrypting module 33, and a storing module 34. The storing unit 30 is provided for storing dot matrix files of texts and bit sequences. The bit sequences are the instructions for watermarking the texts. The text obtaining module 31 is for obtaining the dot matrix file to be watermarked from the storing unit 30.

The pixel determining module 32 is for determining visible pixels to be adjusted. Referring to FIG. 2, the initial brightness values of these pixels before adjusting are [128,128,128], and these pixels are represented as black squares. The pixel determining module 32 further includes a pixel obtaining sub-module 320 and a determining sub-module 321. The pixel obtaining sub-module 320 is for obtaining the pixels to be adjusted. The determining sub-module 321 is for determining the brightness value of each obtained pixel; namely, for determining whether the obtained pixel is visible. Further, the determining sub-module 321 is capable of determining a type of each obtained pixel. That is, the determining sub-module 321 can determine whether the obtained pixel belongs to a dot matrix that represents an alphanumeric character (i.e., an alphabetic character or a numeric character). Preferably, the obtained pixel is an alphanumeric character type pixel, not a punctuation type pixel. In such case, the obtained pixel is considered to be suitable for watermarking. In this description, this kind of obtained pixel is referred to as an earmarked pixel.

The encrypting module 33 is for adjusting the brightness values of earmarked pixels as provided by the pixel determining module 32, according to a predetermined adjustment value. Thereby, the adjusted pixels have different brightness values from the unadjusted visible pixels, and thus provide a means of watermarking. Further, the adjustment can be either an increase or a decrease in the brightness value. However, the adjusted brightness value should be maintained in a predetermined range; e.g., from [0,0,0] to [200,200,200]. The storing module 34 is for storing the watermarked dot matrix files in the storing unit 30.

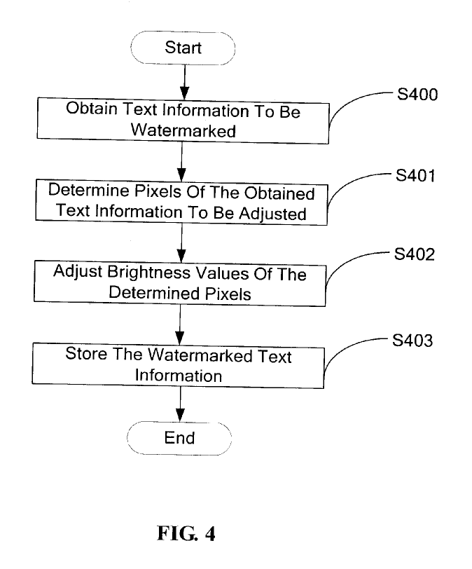

FIG. 4 is a flowchart of a preferred method for digital watermarking in accordance with the present invention. In step S400, the text obtaining module 31 obtains text information, e.g., a dot matrix file, to be watermarked from the storing unit 30. In step S401, the pixel determining module 32 determines which pixels of the obtained dot matrix file are to be adjusted. The earmarked pixels preferably are visible pixels. That is, the initial brightness values of the earmarked pixels preferably are [128,128,128] (i.e., represented as black squares in FIG. 2). The earmarked pixels further preferably are alphanumeric character type pixels. In step S402, the encrypting module 33 adjusts the brightness values of the earmarked pixels according to a predetermined adjustment value. The adjustment can be either an increase or a decrease in the brightness values. However, the adjusted brightness values should be maintained in a predetermined range; e.g., from [0,0,0] to [200,200,200]. In step S403, the storing module 35 stores the watermarked dot matrix in the storing unit 30.

Consequently, by utilizing the steps of FIG. 4, the adjusted pixels have different brightness values from the unadjusted visible pixels. Thereby, the adjusted pixels are represented in different gray levels, and are perceptually different from the unadjusted visible pixels. Therefore, human eyes recognize and distinguish the adjusted pixels from the unadjusted pixels in the text.

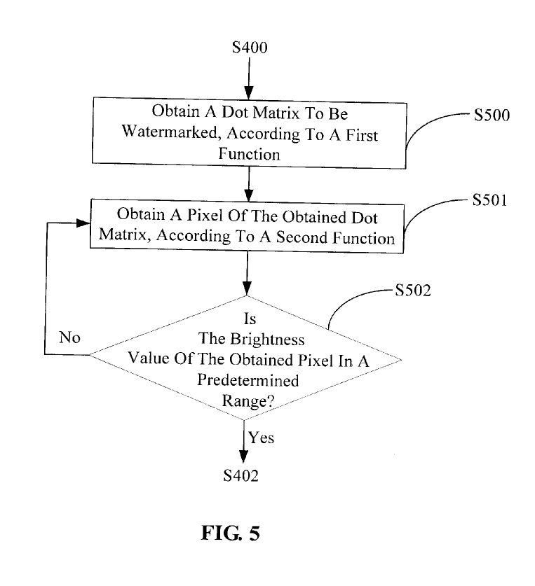

FIG. 5 is a flowchart of a first preferred method of implementing step S401 of FIG. 4, namely determining pixels to be adjusted. In step S500, the pixel obtaining sub-module 320 obtains a dot matrix from the text obtaining module 31, according to a first function as would be known to persons skilled in the relevant art(s). In step S501, the pixel obtaining sub-module 320 obtains a pixel of the obtained dot matrix, according to a second function as would be known to persons skilled in the relevant art(s). In step S502, the determining sub-module 321 determines whether the obtained pixel is visible according to its brightness value. If the obtained pixel is not visible (i.e., represented as a white square in FIG. 2), the procedure goes back to step S501 to obtain a new pixel. Conversely, if the obtained pixel is visible (i.e., represented as a black square in FIG. 2), the procedure goes to step S402 described above. Therefore, by utilizing the steps of FIG. 5, a visible pixel is obtained.

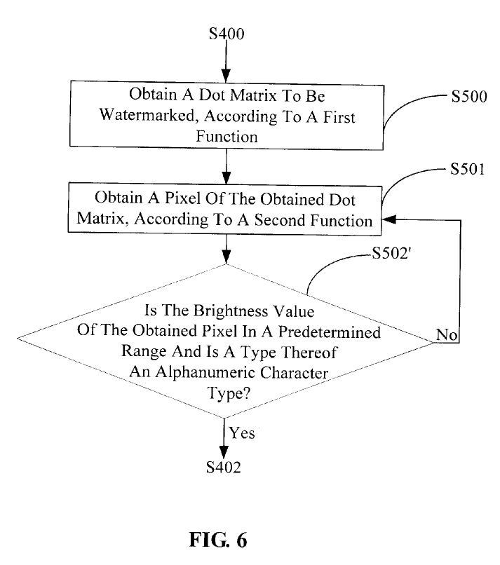

FIG. 6 is a flowchart of a second preferred method of implementing step S401, namely determining pixels to be adjusted. The steps of this flowchart are the same as those of FIG. 5, except that in step S502′, the determining sub-module 321 further determines whether the obtained pixel is also an alphanumeric character type pixel. Correspondingly, by utilizing the steps of FIG. 6, a visible, alphanumeric character type pixel is obtained.

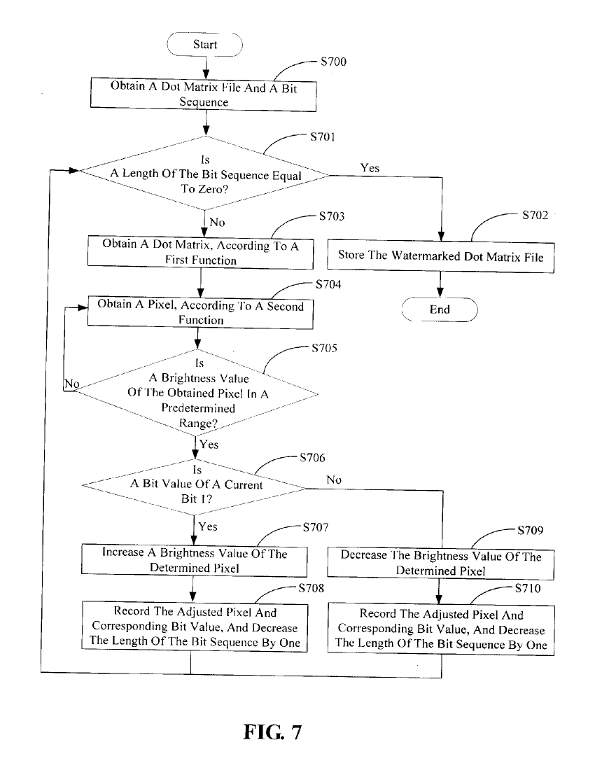

FIG. 7 is a flowchart further detailing steps involved in digital watermarking utilizing a combination of the preferred methods of FIGS. 4 and 5. In step S700, the text obtaining module 31 obtains a dot matrix file to be watermarked and a bit sequence for watermarking from the storing unit 30. The bit sequence may be information indicative of copyright, author, etc. In step S701, the determining sub-module 321 determines whether a length of the bit sequence is equal to zero. If the length of the bit sequence is equal to zero, in step S702, the storing module 34 stores the watermarked dot matrix file, and the procedure is finished. If the length of the bit sequence is not equal to zero, in step S703, the pixel obtaining sub-module 320 obtains a dot matrix from the obtained dot matrix file, according to the first function. In step S704, the pixel obtaining sub-module 320 obtains a pixel from the obtained dot matrix, according to the second function. In step S705, the determining sub-module 321 determines whether the obtained pixel is a visible pixel. If the obtained pixel is not a visible pixel, the procedure goes back to step S704 to obtain a new pixel. If the obtained pixel is a visible pixel, in step S706, the determining sub-module 321 determines whether a bit value of a current obtained bit of the bit sequence is a first value, for example, ‘1’.

If the bit value of the current obtained bit is ‘1’, in step S707, the encrypting module 33 increases the brightness value of the earmarked pixel according to a predetermined adjustment value. Thereby, the gray level of the earmarked pixel is increased, and an adjusted pixel is generated. In step S708, the storing module 34 records the adjusted pixel and the corresponding bit value (i.e., ‘1’), and decreases the length of the bit sequence by one, whereupon the procedure goes back to step S701. Conversely, if the bit value of the current obtained bit is ‘0’, in step S709, the encrypting module 33 decreases the brightness value of the earmarked pixel according to the predetermined adjustment value. Thereby the gray level of the earmarked pixel is decreased, and an adjusted pixel is generated. In step S710, the storing module 34 records the adjusted pixel and the corresponding bit value (i.e., ‘0’), and decreases the length of the bit sequence by one, whereupon the procedure goes back to step S701.

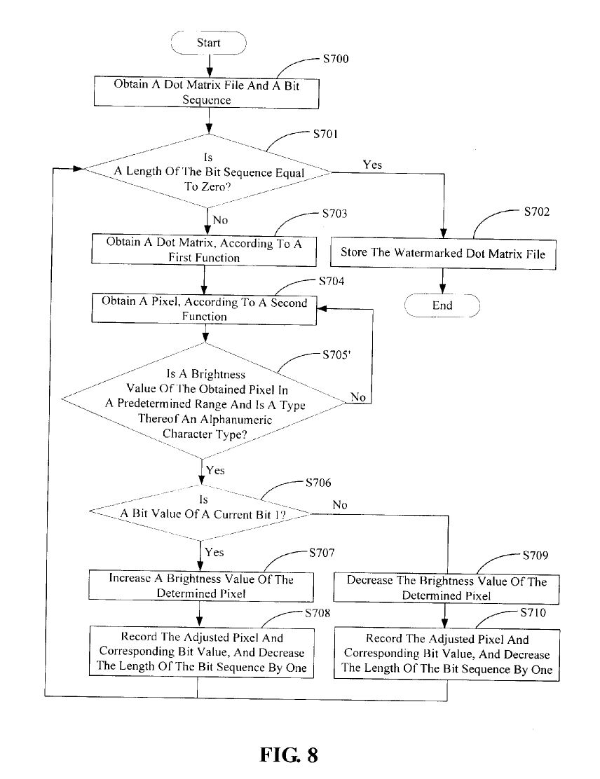

FIG. 8 is flowchart further detailing steps involved in digital watermarking utilizing a combination of the preferred methods of FIGS. 4 and 6. The steps of this flowchart are the same as those of FIG. 7, except that in step S705′, the determining sub-module 321 further determines whether the type of the obtained pixel is an alphanumeric character type pixel. If the obtained pixel is both a visible pixel and an alphanumeric character type pixel, the procedure goes to step S706. Otherwise, the procedure goes back to step S704.

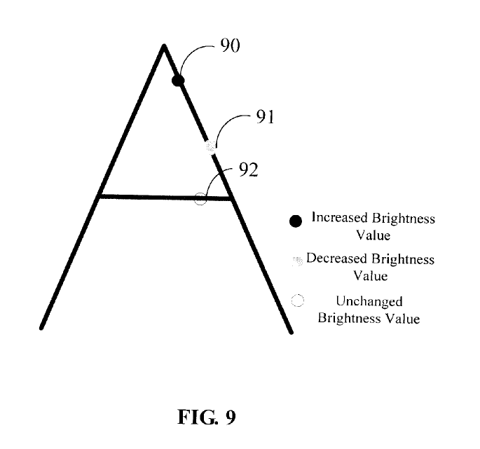

FIG. 9 illustrates results of a watermarked dot matrix obtained by utilizing the method of either FIG. 7 or FIG. 8. By utilizing the steps of either FIG. 7 or FIG. 8 described above, a dot matrix file (i.e., a text) is watermarked. For the sake of simplicity, in FIG. 9, a single watermarked alphabetic character dot matrix of the dot matrix file is illustrated; namely, the English language capital letter ‘A’. As described above, the brightness values of the determined pixels can be either increased or decreased. Accordingly, the adjusted pixel can be displayed in either a darker mode (e.g., the pixel labeled 90) or a brighter mode (e.g., the pixel labeled 91), as compared to the unadjusted pixels (e.g., the pixel labeled 92). Consequently, the adjusted pixels are distinguishable from the unadjusted pixels by the human eye. This means the corresponding text has a visible difference from the normal unwatermarked text. Thereby, pirates who reproduce the text reproduce the digital watermark, and it is easier for the pirated text to be traced back to the master copy of the text.

It is to be noted that even though English language alphabetic characters are described above and/or exemplified in the drawings, this is for the purposes of conveniently illustrating exemplary embodiments of the present invention. The principles exemplified in the above description and drawings herein are equally applicable to alphabetic characters of various other languages. Further, even though Arabic numeral numeric characters are described above and/or exemplified in the drawings, this is for the purposes of conveniently illustrating exemplary embodiments of the present invention. The principles exemplified in the above description and drawings herein are equally applicable to numeric characters of various other numeral systems (such as Chinese, Japanese, etc). Moreover, even though English language punctuation mark characters are described above and/or exemplified in the drawings, this is for the purposes of conveniently illustrating exemplary embodiments of the present invention. The principles exemplified in the above description and drawings herein are equally applicable to various non-alphanumeric text characters, markings or symbols such as pronunciation symbols, asterisks, stars, hash symbols, mathematical symbols, value symbols, position symbols, etc.

It is to be further noted that although the present invention has been specifically described on the basis of preferred embodiments and preferred methods, the invention is not to be construed as being limited thereto. Various changes or modifications may be made to the embodiment and methods without departing from the scope and spirit of the invention.

What is claimed is:

1. A digital watermarking system comprising:
a storing unit for storing text information, the text information comprising one or more dot matrix files;
a text obtaining module, for obtaining a dot matrix file to be watermarked from the storing unit, wherein the dot matrix file comprises a plurality of dot matrixes, each of the dot matrixes comprises a plurality of pixels, and each of the pixels has a brightness value;
a pixel determining module for earmarking a pixel to be adjusted, wherein an initial brightness value of the earmarked pixel is in a predetermined range;
an encrypting module, for adjusting the brightness value of the earmarked pixel; and
a storing module, for storing watermarked text information in the storing unit.

2. The digital watermarking system according to claim 1, wherein the adjustment of the brightness value of the earmarked pixel is selected from the group consisting of increasing the brightness value and decreasing the brightness value.

3. The digital watermarking system according to claim 2, wherein the pixel determining module further comprises a pixel obtaining sub-module and a determining sub-module, the pixel obtaining sub-module is for obtaining a pixel to be adjusted, and the determining sub-module is for determining the initial brightness value of the obtained pixel.

4. The digital watermarking system according to claim 3, wherein the pixel obtaining sub-module is also for obtaining a new pixel to be adjusted if the initial brightness value of the obtained pixel is out of the predetermined range.

5. The digital watermarking system according to claim 4, wherein each obtained pixel is defined to be of one of at least two types, according to a type of text that the corresponding dot matrix represents, the at least two types comprise an alphanumeric character type and a punctuation type, and the alphanumeric character type comprises an item selected from the group consisting of an alphabetic character type and a numeric character type.

6. The digital watermarking system according to claim 5, wherein a type of the earmarked pixel is the alphanumeric character type.

7. The digital watermarking system according to claim 6, wherein the pixel obtaining sub-module is also for obtaining a new pixel to be adjusted if a type of the obtained pixel is the punctuation type.

8. A digital watermarking method comprising the steps of:
obtaining text information to be watermarked, wherein the text information comprises one or more dot matrix files, each of the dot matrix files comprises a plurality of dot matrixes, each of the dot matrixes comprises a plurality of pixels, and each of the pixels has an initial brightness value;
earmarking a pixel to be adjusted, wherein an initial brightness value of the earmarked pixel is in a predetermined range;
adjusting the brightness value of the earmarked pixel; and
storing watermarked text information in a storing unit.

9. The digital watermarking method according to claim 8, wherein the adjustment of the brightness value of the earmarked pixel is selected from the group consisting of increasing the brightness value and decreasing the brightness value.

10. The digital watermarking method according to claim 9, wherein each earmarked pixel is defined to be of one of at least two types, according to a type of text that the corresponding dot matrix represents, the at least two types comprise an alphanumeric character type and a punctuation type, and the alphanumeric character type comprises an item selected from the group consisting of an alphabetic character type and a numeric character type.

11. The digital watermarking method according to claim 10, wherein a type of the earmarked pixel is the alphanumeric character type.

12. A digital watermarking method comprising the steps of:
obtaining text information to be watermarked, wherein the text information comprises one or more dot matrix files, each of the dot matrix files comprises a plurality of dot matrixes, each of the dot matrixes comprises a plurality of pixels, and each of the pixels has an initial brightness value;
obtaining a dot matrix from the obtained text information if a length of a bit sequence is not equal to zero, wherein the bit sequence comprises an instruction for watermarking the text information;
earmarking a pixel of the obtained dot matrix, if the brightness value of the pixel is in a predetermined range;
adjusting the brightness value of the earmarked pixel according to a bit value of one bit of the bit sequence;
recording the adjusted pixel and corresponding bit value; and
storing watermarked text information.

13. The digital watermarking method according to claim 12, wherein the step of adjusting the brightness value of the earmarked pixel according to a bit value of one bit of the bit sequence further comprises the steps of:
increasing the brightness value of the earmarked pixel if the bit value is equal to a first value; or
decreasing the brightness value of the earmarked pixel if the bit value is equal to a second value.

14. The digital watermarking method according to claim 13, wherein each earmarked pixel is defined to be of one of at least two types, according to a type of text that the corresponding dot matrix represents, the at least two types comprise an alphanumeric character type and a punctuation type, and the alphanumeric character type comprises an item selected from the group consisting of an alphabetic character type and a numeric character type.

15. The digital watermarking method according to claim 14, wherein a type of the earmarked pixel is the alphanumeric character type.
